(19) United States
(12) Patent Application Publication
(10) Pub. No.: US 2017/0320980 A1
(43) Pub. Date: Nov. 9, 2017

(54) RANDOM-SYNDIOTACTIC BLOCK POLYBUTADIENE AND PREPARATION METHOD THEREOF

(71) Applicant: CHANGGHUN INSTITUTE OF APPLIED CHEMISTRY, CHINESE ACADEMY OF SCIENCES, Changchun City, Jilin (CN)

(72) Inventors: Xuequan ZHANG, Changchun City (CN); Wenjie ZHENG, Changchun City (CN); Yanming HU, Changchun City (CN); Chunyu ZHANG, Changchun City (CN); Jifu BI, Changchun City (CN)

(73) Assignee: CHANGGHUN INSTITUTE OF APPLIED CHEMISTRY, CHINESE ACADEMY OF SCIENCES, Changchun City, Jilin (CN)

(21) Appl. No.: 15/525,010

(22) PCT Filed: Nov. 19, 2014
(86) PCT No.: PCT/CN2014/091577

§ 371 Date: May 5, 2017

(51) Int. Cl. C08F 136/06; C08F 297/08

(52) U.S. Cl. CPC C08F 136/06; C08F 297/08

(57) ABSTRACT

The present invention relates to the field of polymer materials. Disclosed are a random-syndiotactic block polybutadiene and preparation method thereof, the provided random-syndiotactic block polybutadiene having a structure of formula (I), and comprising a random polybutadiene structure and a syndiotactic 1, 2-polybutadiene structure, being useful as a compatibilizing agent to improve the compatibility of the syndiotactic 1, 2-polybutadiene/polybutadiene rubber blend. Experimental results show that, compared to a purely syndiotactic 1, 2-polybutadiene/polybutadiene rubber blend, the addition of the random-syndiotactic block polybutadiene thereto significantly improves the compatibility

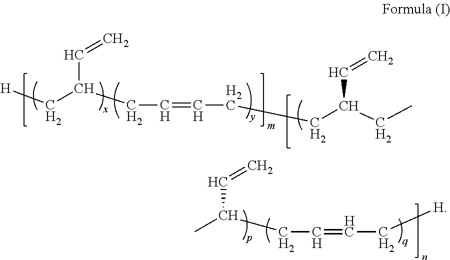

### CROSS REFERENCE TO RELATED APPLICATION(S)

This application is a National Phase patent application of International Patent Application Number PCT/CN2014/091577, filed on Nov. 19, 2014. The contents of which are included herein by reference.

### TECHNICAL FIELD

The present invention relates to the field of polymer materials, and especially to a random-syndiotactic block polybutadiene and preparation method thereof.

### BACKGROUND

A syndiotactic 1,2-polybutadiene is a crystalline thermoplastic elastomer, which can be used for manufacturing thin films, fibers and injection molded products, and in particular, a syndiotactic 1,2-polybutadiene having a high melting point and high crystallinity can be used as a rubber reinforced material for tires. Ube Company in Japan has found that application of a syndiotactic 1,2-polybutadiene modified polybutadiene rubber in the manufacture of an automobile tire, in particular a radial tire, can improve the abrasion resistance of the tire and reduce the heat generation while the tire running.

Heating treatment is generally required in blending a syndiotactic 1,2-polybutadiene and a polybutadiene rubber, and due to a large number of pendant vinyl groups comprised in the molecular chain of the syndiotactic 1,2-polybutadiene, degradation, branching and cross-linking reactions of such a polymer can inevitably occur during the high-temperature processing, and the high-temperature processing will lead to high energy consumption, thereby increasing the manufacturing cost. Therefore, in order to solve the cross-linking and energy consumption issues during the mixing of the syndiotactic 1,2-polybutadiene and polybutadiene rubber, Bridgestone Corporation in Japan has developed a technology for preparing a syndiotactic 1,2-polybutadiene/polybutadiene rubber blend by polymerizating butadiene monomer in a polybutadiene glue solution. Although the syndiotactic 1,2-polybutadiene/polybutadiene rubber blend prepared by using this technology reduces the degradation, branching and cross-linking of a syndiotactic 1,2-polybutadiene in some extent, the syndiotactic 1,2-polybutadiene in the blend has a larger aggregated phase region, allowing rubber products prepared by using this technology have a significantly reduced mechanical strength in use.

It follows that, in order to improve the mechanical strength of a syndiotactic 1,2-polybutadiene modified polybutadiene rubber, it is necessary to reduce the aggregated phase region of the syndiotactic 1,2-polybutadiene in the syndiotactic 1,2-polybutadiene/polybutadiene rubber blend and improve the compatibility of the syndiotactic 1,2-polybutadiene and the polybutadiene rubber. However, there is no suitable compatibilizing agent found currently, which is used to improve the compatibility of the syndiotactic 1,2-polybutadiene and the polybutadiene rubber.

### SUMMARY OF THE INVENTION

In view of this, an object of the present invention is to provide a random-syndiotactic block polybutadiene and preparation method thereof, and the random-syndiotactic block polybutadiene provided by the present invention can be used as a compatibilizing agent to improve the compatibility of a syndiotactic 1,2-polybutadiene/polybutadiene rubber blend.

The present invention provides a random-syndiotactic block polybutadiene having a structure of formula (I):

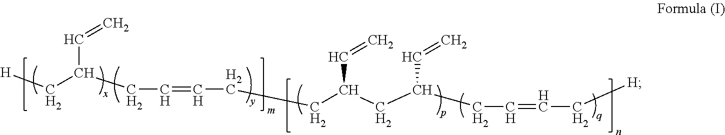

wherein 250≦m≦5000; 100≦n≦3000; 100≦x≦3000; 150≦y≦2000, x+y=m; 70≦p≦2500, 30≦q≦500, p+q=n.

Preferably, 500≦m≦2500; 300≦n≦1500; 200≦x≦1500, 300≦y≦1000; 150≦p≦1250, 50≦q≦250.

The present invention provides a method for preparing a random-syndiotactic block polybutadiene, comprising the steps of:

a) mixing 1,3-butadiene, a catalyst and a solvent to carry out a reaction, obtaining a prepolymer;

b) mixing the prepolymer, 1,3-butadiene, an organic-aluminum compound and a solvent to carry out a reaction, obtaining a random-syndiotactic block polybutadiene having a structure of formula (I);

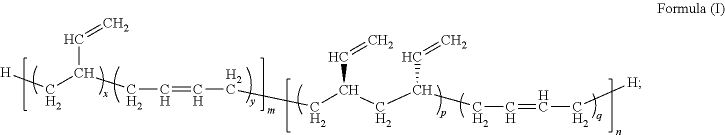

wherein 250≦m≦5000; 100≦n≦3000; 100≦x≦3000, 150≦y≦2000, x+y=m; 70≦p≦2500, 30≦q≦500, p+q=n.

Preferably, in step a), the ratio of the 1,3-butadiene to the catalyst is 1˜10 (g):0.01˜10 (mmol).

Preferably, in step a), the duration of the reaction is 1˜6 h; and the temperature of the reaction is 30˜80° C.

Preferably, in step b), the organic-aluminum compound is one or more of triethyl aluminum, triisobutyl aluminum, and diisobutylaluminum hydride.

Preferably, in step b), the ratio of the 1,3-butadiene to the organic-aluminum compound is 7˜3 (g):0.1˜5 (mmol).

Preferably, in step b), the duration of the reaction is 1˜4 h; and the temperature of the reaction is 30˜80° C.

Preferably, the mass ratio of the 1,3-butadiene in step a) to the 1,3-butadiene in step b) is 3˜7:7˜3.

Preferably, the catalyst is an organic-iron compound, an organic-aluminum compound and/or a dialkyl hydrogen phosphite compound.

In contrast to the prior art, the present invention provides a random-syndiotactic block polybutadiene and preparation method thereof. The random-syndiotactic block polybutadiene provided by the present invention has a structure of formula (I), wherein 250≦m≦5000; 100≦n≦3000; 100≦x≦3000, 150≦y≦2000, x+y=m; 70≦p≦2500, 30≦q≦500, p+q=n. The random-syndiotactic block polybutadiene provided by the present invention comprises a random polybutadiene structure and a syndiotactic 1,2-polybutadiene structure, being useful as a compatibilizing agent to improve the compatibility of the syndiotactic 1,2-polybutadiene/polybutadiene rubber. Experimental results show that, compared to a purely syndiotactic 1,2-polybutadiene/polybutadiene rubber blend, the addition of the random-syndiotactic block polybutadiene thereto significantly improves the compatibility.

### BRIEF DESCRIPTION OF THE FIGURES

FIG. 1 is a ¹³C NMR spectrum of the random-syndiotactic block polybutadiene prepared in Example 1 of the present invention.

FIG. 2 is a ¹H NMR spectrum of the prepolymer prepared by the polymerization reaction in the first step in Example 1 of the present invention.

FIG. 3 is a ¹H NMR spectrum of the random-syndiotactic block polybutadiene prepared in Example 1 of the present invention,

FIG. 4 is a WAXD diagram of the random-syndiotactic block polybutadiene prepared in Example 1 of the present invention.

FIG. 5 is a GPC curve of the random-syndiotactic block polybutadiene prepared in Example 1 of the present invention.

FIG. 6 is a DSC curve of the random-syndiotactic block polybutadiene prepared in Example 1 of the present invention.

FIG. 7 is a TEM image of the random-syndiotactic block polybutadiene prepared in Example 1 of the present invention.

FIG. 8 is a TEM image of a mixture of polymers prepared in Comparative example 1 and Comparative example 2 of the present invention.

FIG. 9 is a TEM image of a mixture of polymers prepared in Example 1, Comparative example 1 and Comparative example 2 of the present invention.

### DETAILED DESCRIPTION

For further understanding of the present invention, preferred embodiments of the present invention will be described in conjunction with examples, however, it is to be understood that these descriptions are intended to further illustrate the features and advantages of the present invention, rather than to limit the claims of the present invention.

The invention provides a random-syndiotactic block polybutadiene having a structure of formula (I):

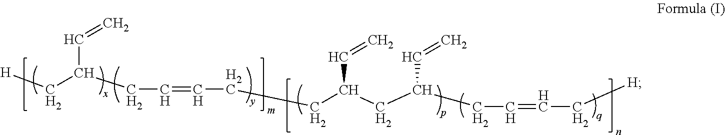

wherein 250≦m≦5000; 100≦n≦3000; 100≦x≦3000, 150≦y≦2000, x+y=m; 70≦p≦2500, 30≦q≦500, p+q=n.

The random-syndiotactic block polybutadiene provided by the present invention has a structure of formula (I), wherein 250≦m≦5000, preferably 750≦m≦2700; 100≦n≦3000, preferably 350≦n≦1550; 100≦x≦3000, preferably 350≦x≦1500; 150≦y≦2000, preferably 400≦y≦1200; 70≦p≦2500, preferably 250≦p≦1250; 30≦q≦500, preferably 100≦q≦300; x+y=m, p+q=n.

In the present invention, the random-syndiotactic block polybutadiene has a number-average molecular weight of preferably 3×10⁴˜50×10⁴, more preferably 10×10⁴˜30×10⁴, most preferably 11×10⁴˜28×10⁴. The random-syndiotactic block polybutadiene consists of random blocks and syndiotactic blocks, with the mass ratio of the random block to the syndiotactic block being preferably 10˜80:90˜20, more preferably 30˜70:70˜30.

Wherein the structure of the random block is shown in formula (III):

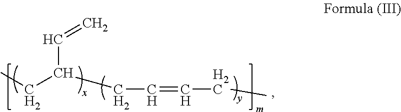

wherein 250≦m≦5000; 100≦x≦3000, 150≦y≦2000, x+y=m.

In the present invention, the random block consists of repeating units having a 1,2-butadiene structure and repeating units having a cis-1,4-butadiene structure, wherein the arrangement of the repeating units having a 1,2-butadiene structure and the repeating units having a cis-1,4-butadiene structure is arranged disorderly. The repeating units having a 1,2-butadiene structure in this random block has a mass content of preferably 30˜80 wt %, more preferably 40˜60 wt %, most preferably 43˜58 wt %.

The structure of the syndiotactic block is as shown in formula (IV):

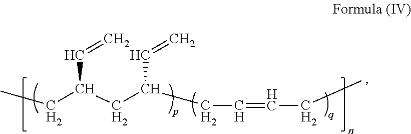

wherein 100≦n≦3000; 70≦p≦2500, 30≦q≦500, p+q=n.

In the present invention, the syndiotactic block consists of segments having a syndiotactic 1,2-polybutadiene structure and repeating units having a cis-1,4-butadiene structure, wherein the segments having a syndiotactic 1,2-polybutadiene structure consist of alternating repeating units with configuration of optical isomerism The arrangement of the segments having a syndiotactic 1,2-polybutadiene structure and the repeating units having a cis-1,4-butadiene structure in the syndiotactic block is disordered. The repeating unit having a 1,2-butadiene structure in the syndiotactic block has a mass content of preferably 60˜95 wt %, more preferably 75˜95 wt %, most preferably 81˜94 wt %.

In the present invention, the random block consists of several random segments; and the syndiotactic block consists of several syndiotactic segments. The random-syndiotactic block polybutadiene provided by the present invention in fact is a linear copolymer consisting of random alternating arrangement of the random segments and the syndiotactic segments, belonging to a random block copolymer.

The random-syndiotactic block polybutadiene provided by the present invention comprises a random polybutadiene structure and a syndiotactic 1,2-polybutadiene structure, which is useful as a compatibilizing agent to improve the compatibility of the syndiotactic 1,2-polybutadiene and polybutadiene rubber, thereby improving the physicochemical properties of the syndiotactic 1,2-polybutadiene/polybutadiene rubber blend. In addition, since the random-syndiotactic block polybutadiene provided by the present invention has a random polybutadiene structure and a syndiotactic 1,2-polybutadiene structure, the random-syndiotactic block polybutadiene provided by the present invention has both the physicochemical properties of the syndiotactic 1,2-polybutadiene thermoplastic elastomer and the polybutadiene rubber, and can be used as a raw material for producing high-performance tires and rubber articles. Experimental results show that, compared to a purely syndiotactic 1,2-polybutadiene/polybutadiene rubber blend, the addition of the random-syndiotactic block polybutadiene provided by the present invention thereto significantly improves the compatibility.

The present invention provides a method for preparing a random-syndiotactic block polybutadiene, comprising the steps of:

a) mixing 1,3-butadiene, a catalyst and a solvent to carry out a reaction, obtaining a prepolymer;

b) mixing the prepolymer, 1,3-butadiene, an organic-aluminum compound and a solvent to carry out a reaction, obtaining a random-syndiotactic block polybutadiene having a structure of formula (I);

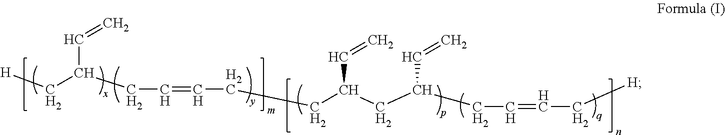

wherein 250≦m≦5000; 100≦n≦3000; 100≦x≦3000, 150≦y≦2000, x+y=m; 70≦p≦2500, 30≦q≦500, p+q=n.

In the preparation method of the present invention, step a) is carried out first, which is specifically as follows:

1,3-butadiene, a catalyst and a solvent are mixed, wherein the catalyst is preferably an organic-iron compound, an organic-aluminum compound and a dialkyl hydrogen phosphite compound. The organic-iron compound is preferably one or more of ferric isooctanoate, ferrous isooctanoate, ferric naphthenate, ferrous naphthenate, ferric neodecanoate, ferric acetylacetonate and ferrous acetylacetonate; the organic-aluminum compound is preferably one or more of triethyl aluminum ([Al(C₂H₅)₃]), triisobutyl aluminum ([Al(i-C₄H₉)₃]) and diisobutylaluminum hydride ([AlH(i-C₄H₉)₂]); the dialkyl hydrogen phosphite compound is preferably one or more of dimethyl phosphite, diethyl phosphite, dibutyl phosphite and diphenyl phosphite. The mole ratio of the organic-iron compound, organic-aluminum compound and dialkyl hydrogen phosphite compound is preferably 1:2˜10:0.5˜5, more preferably 1:3˜10:1˜3, most preferably 1:5˜8:1˜3. The ratio of the catalyst to the 1,3-butadiene is preferably 0.01˜10 (mmol):1˜10 (g), more preferably 0.1˜1 (mmol):1˜10 (g), most preferably 0.2˜0.5 (mmol):3˜7 (g). The solvent is preferably a nonpolar organic solvent, more preferably a nonpolar aliphatic hydrocarbon and nonpolar aromatic hydrocarbon, most preferably pentane, hexane, heptane, octane, cyclohexane, benzene, toluene, ethylbenzene, xylene or raffinate oil, further most preferably hexane, cyclohexane or raffinate oil. The mass ratio of the solvent to the 1,3-butadiene is preferably 95˜60:5˜40, more preferably 90˜80:10˜20. The 1,3-butadiene, catalyst and solvent are homogeneously mixed and then reacted. The temperature of the reaction is preferably 30˜80° C., more preferably 50˜80° C.; and the duration of the reaction is 1˜6 h, more preferably 4˜6 h. After the completion of the reaction, a prepolymer is obtained.

After obtaining the prepolymer, step b) is carried out, which is specifically as follows:

The prepolymer, 1,3-butadiene, organic-aluminum compound, and solvent are mixed, wherein the organic-aluminum compound is preferably one or more of triethyl aluminum ([Al(C₂H₅)₃]), triisobutyl aluminum ([Al(i-C₄H₉)₃]), and diisobutylaluminum hydride ([AlH(i-C₄H₉)₂]); the solvent is preferably a nonpolar organic solvent, more preferably a nonpolar aliphatic hydrocarbon and/or a nonpolar aromatic hydrocarbon, most preferably pentane, hexane, heptane, octane, cyclohexane, benzene, toluene, ethylbenzene, xylene or raffinate oil, further most preferably hexane, cyclohexane or raffinate oil. The ratio of the 1,3-butadiene to the organic-aluminum compound is preferably 7˜3 (g):0.1˜5 (mmol), more preferably 7˜3 (g):0.2˜3 (mmol), most preferably 7˜3 (g):0.46˜1.4 (mmol). The mass ratio of the solvent to the 1,3-butadiene is preferably 95˜60:5˜40, more preferably 90˜80:10˜20. The mass ratio of the 1,3-butadiene in step a) to the 1,3-butadiene in step b) is preferably 3 7:7˜3.

The prepolymer, 1,3-butadiene, organic-aluminum compound and solvent are homogeneously mixed and then reacted. The temperature of the reaction is preferably 30˜80° C., more preferably 50˜80° C.; and the duration of the reaction is 1˜4 h, more preferably 2˜4 h. After the required reaction time, a chain terminator is added to the reaction system consisting of the prepolymer, 1,3-butadiene, organic-aluminum compound and solvent to stop the reaction, obtaining a reaction product solution. The chain terminator is preferably a solution of 2,6-di-tert-butyl-p-cresol in ethanol. The mass content of the 2,6-di-tert-butyl-p-cresol in the solution of 2,6-di-tert-butyl-p-cresol in ethanol is preferably 0.1˜5 wt %, more preferably 1˜2 wt %. The reaction product solution is subjected to a post-treatment, obtaining a random-syndiotactic block polybutadiene represented by formula (I). The procedure of the post-treatment is preferably that, the reaction product solution is successively precipitated with ethanol and dried, obtaining a random-syndiotactic block polybutadiene represented by formula (I). The drying temperature is preferably 30˜50° C., more preferably 30˜40° C.

The preparation method provided by the present invention can prepare the random-syndiotactic block polybutadiene represented by formula (I). This polybutadiene is useful as a compatibilizing agent to improve the compatibility of the syndiotactic 1,2-polybutadiene/polybutadiene rubber blend, thereby improving the physicochemical properties of the syndiotactic 1,2-polybutadiene/polybutadiene rubber blend.

For more clarity, the present invention will be described in more detail by the following examples.

### Example 1

Under nitrogen protection, 58 mL of hexane and 7 g of 1,3-butadiene were added to a 120 mL baked polymerization bottle, and then 0.54 mL of a hexane solution comprising 0.054 mmol ferric isooctanoate, 0.82 mL of a hexane solution comprising 0.164 mmol diethyl hydrogen phosphite and 0.28 mL of a hexane solution comprising 0.28 mmol triisobutyl aluminum were sequentially added. After shaken up, it was placed into a thermostatic water bath at 50° C. to carry out the first polymerization reaction. After polymerization for 4 h, 1.4 mL of a hexane solution comprising 1.4 mmol triisobutyl aluminum and 25 mL of a hexane solution comprising 3 g 1,3-butadiene were added to the polymerization bottle to carry out the second polymerization reaction. After polymerization for 2 h, an ethanol solution comprising 1 wt % 2,6-di-tert-butyl-p-cresol was added to the polymerization bottle to stop the reaction, obtaining a reaction product solution. The reaction product solution was subjected to ethanol for precipitation, and then dried to a constant weight in a vacuum oven at 40° C., obtaining a random-syndiotactic block polybutadiene with a yield of 75%.

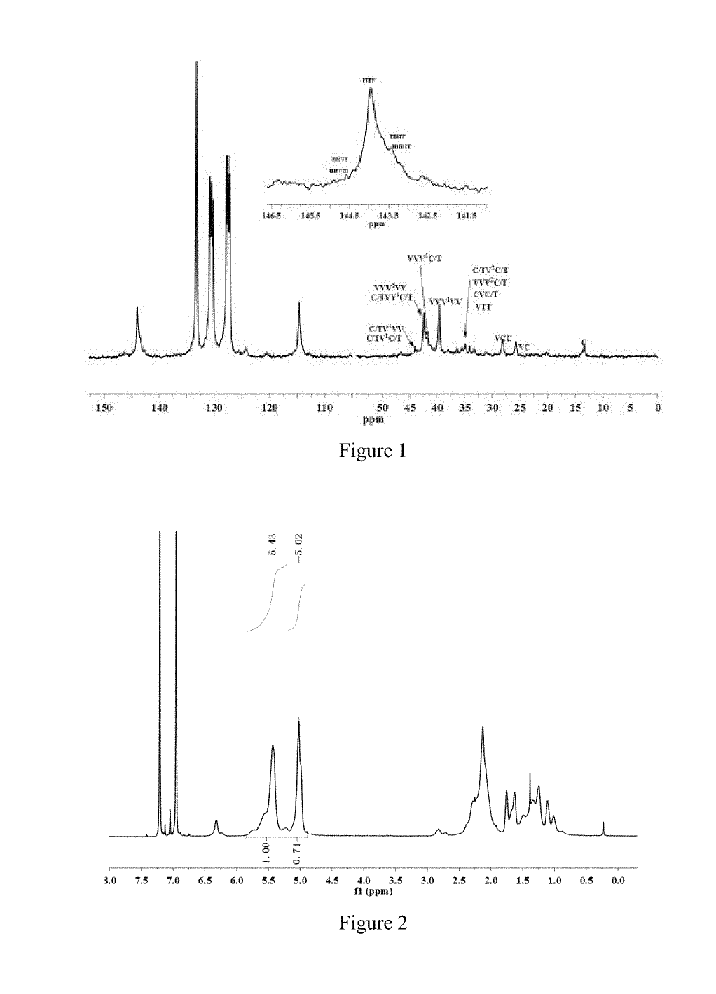

The random-syndiotactic block polybutadiene prepared by this example was analyzed by carbon nuclear magnetic resonance (NMR) spectrometry, and results are shown in FIG. 1. FIG. 1 is a ¹³C NMR spectrum of the random-syndiotactic block polybutadiene prepared in Example 1 of the present invention, wherein C/TV¹C/T represents

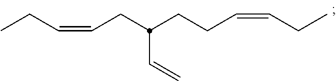

C/TV¹VV represents

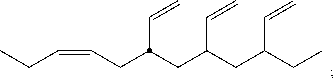 [SMILES: C=CC(CC)CC(C=C)C[C@@H](C=C)C/C=C\CC]

C/TVV¹C/T represents

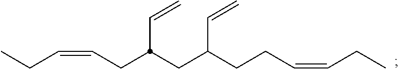 [SMILES: C=CC(CC/C=C\CC)C[C@@H](C=C)C/C=C\CC]

VVV²VV represents

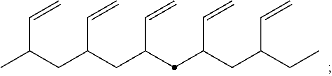

VVV¹C/T represents

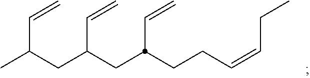 [SMILES: C=CC(C)CC(C=C)C[C@H](C=C)CC/C=C\CC]

VVV¹VV represents

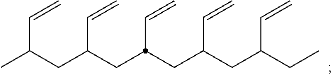 [SMILES: C=CC(C)CC(C=C)C[C@H](C=C)CC(C=C)CC(C=C)CC]

CTV²C/T represents

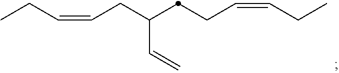

VVV²C/T represents

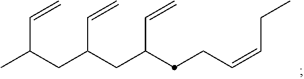

CVC/T represents

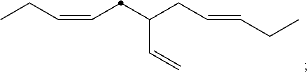

VTT represents

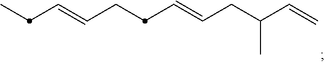

VCC represents

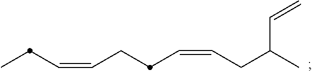

VC represents

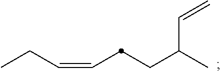

C represents

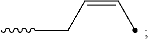

rrrr, mrrr, mrrm, rmrr and mmrr represent the quintuple of the syndiotactic 1,2-polybutadiene.

As can be seen from FIG. 1, the characteristic peak of methylene carbons in the 1,2-butadiene structure presents at δ=115 ppm; the characteristic peak of methylidyne carbons in the 1,2-butadiene structure presents at δ=144 ppm; the characteristic peaks of the quintuple (rrrr, mrrr, mrrm, rmrr and mmrr) of the syndiotactic 1,2-polybutadiene presents at δ=114.7˜143.9 ppm; and the characteristic peaks of the aliphatic carbons in C/TV¹C/T, C/TV¹VV, C/TVV¹C/T, VVV²VV, VVV¹C/T, VVV¹VV, CTV²C/T, VVV²C/T, CVC/T, VTT, VCC, VC and C structures presents at δ=10˜45 ppm.

By analyzing the random-syndiotactic block polybutadiene prepared by this example by carbon nuclear magnetic resonance (NMR) spectrometry, it can be seen that this random-syndiotactic block polybutadiene comprises repeating units having a 1,2-butadiene structure, repeating units having a cis-1,4-butadiene structure and segments having a syndiotactic 1,2-polybutadiene structure.

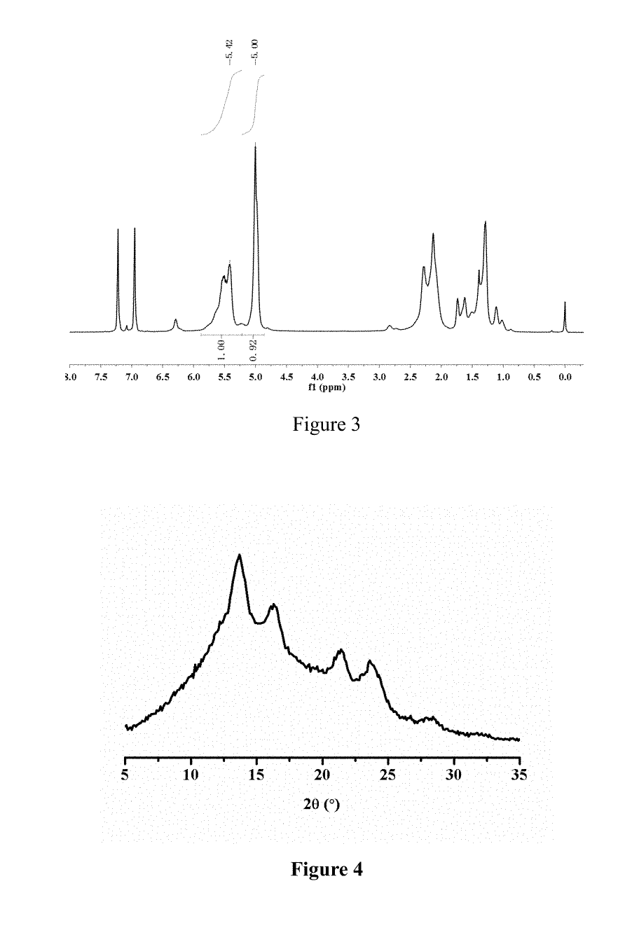

The random-syndiotactic block polybutadiene prepared by this example and the prepolymer prepared by the first polymerization reaction were analyzed by hydrogen nuclear magnetic resonance (NMR) spectrometry, and results are shown in FIG. 2 and FIG. 3. FIG. 2 is a ¹H NMR spectrum of the prepolymer prepared by the first polymerization reaction in Example 1 of the present invention, wherein the integrated area at δ=4.8˜5.5 ppm is an integrated area of methylene hydrogens on the repeating units having a 1,2-butadiene structure; the integrated area at δ=5.32˜5.78 ppm is a sum of the integrated area of methylidyne hydrogens on the repeating units having a 1,2-butadiene structure and the integrated area of methylidyne hydrogens on the repeating units having a cis-1,4-butadiene structure. FIG. 3 is a ¹H NMR spectrum of the random-syndiotactic block polybutadiene prepared in Example 1 of the present invention, wherein the integrated area at δ=4.8˜5.5 ppm is an integrated area of methylene hydrogens on the repeating units having a 1,2-butadiene structure; the integrated area at δ=5.32˜5.78 ppm is a sum of the integrated area of methylidyne hydrogens on the repeating units having a 1,2-butadiene structure and the integrated area of methylidyne hydrogens on the repeating units having a cis-1,4-butadiene structure.

It is calculated based on the integrated area data in FIG. 2 that, the prepolymer prepared by the first polymerization reaction in this example, that is, the 1,2-butadiene structure in the random block of the random-syndiotactic block polybutadiene prepared by this example has a content of 52.4 wt %. It is calculated based on the integrated area data in FIG. 3 that, the total content of the 1,2-butadiene structure in the random-syndiotactic block polybutadiene prepared by this example is 63.0 wt %.

The random-syndiotactic block polybutadiene prepared by this example was analyzed by wide angle X-ray diffraction (WAXD), and results are shown in FIG. 4. FIG. 4 is a WAXD diagram of the random-syndiotactic block polybutadiene prepared in Example 1 of the present invention.

As can be seen from FIG. 4, the random-syndiotactic block polybutadiene prepared by this example presents four characteristic diffraction peaks: 2θ=13.7°, 16.3°, 21.5°, 23.8°, due to the crystallization of the segments having a syndiotactic 1,2-polybutadiene structure in the polymer. This illustrated that this random-syndiotactic block polybutadiene comprises the segments having a syndiotactic 1,2-polybutadiene structure.

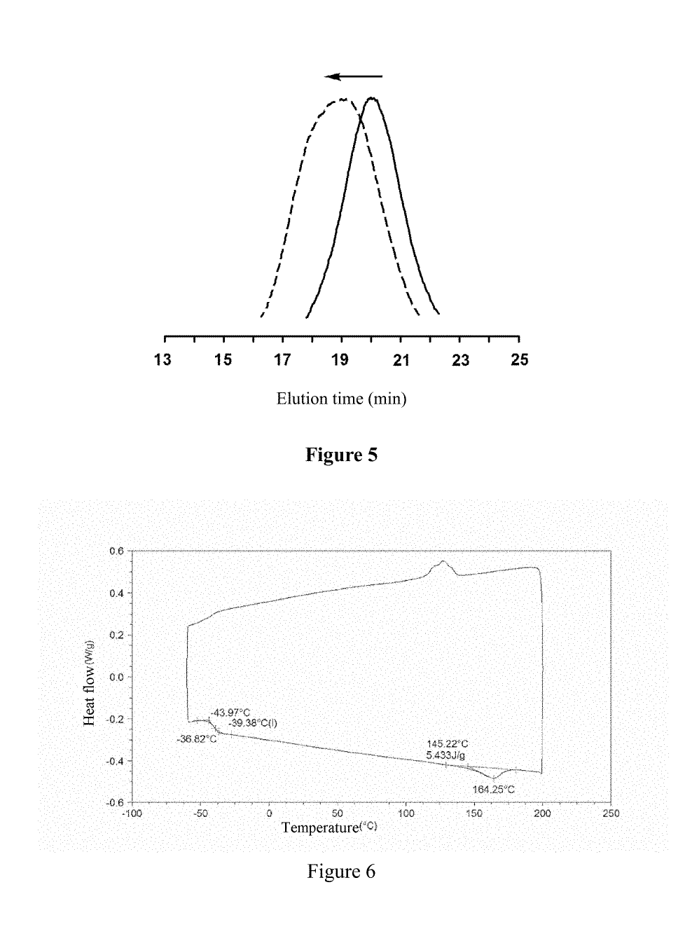

The random-syndiotactic block polybutadiene prepared by this example was analyzed by gel permeation chromatography (GPC), and results are shown in FIG. 5. FIG. 5 is a GPC curve of the random-syndiotactic block polybutadiene prepared in Example 1 of the present invention, wherein the solid line is a GPC curve of the product obtained in the first polymerization reaction, and the dotted line is a GPC curve of the product obtained in the second polymerization reaction.

As can be seen from FIG. 5, the product obtained upon the second polymerization reaction moves toward the high molecular weight, and is still unimodal. This illustrates that the product obtained in the second polymerization reaction is a polymer, rather than a mixture of the polymers obtained in both the polymerization reactions, thus demonstrating that the random-syndiotactic block polybutadiene prepared by this example is a polymer having a block structure.

The random-syndiotactic block polybutadiene prepared by this example was analyzed by differential scanning calorimetry (DSC). Results are shown in FIG. 6, and FIG. 6 is a DSC curve of the random-syndiotactic block polybutadiene prepared in Example 1 of the present invention.

As can be seen from FIG. 6, the random-syndiotactic block polybutadiene prepared by this example has a glass-transition temperature (Tg) of −39.4° C. and a melting point (Tm) of 164.3° C.

The random-syndiotactic block polybutadiene prepared by this example was detected for its molecular weight, and results are that: a number-average molecular weight is 11.1×10⁴, a molecular weight distribution index is 2.29.

It can be seen from the analysis above that, the random-syndiotactic block polybutadiene prepared by this example has a structure of formula (I), wherein m=1430, n=350, x=750, y=680, p=270, q=80. The mass ratio between the random blocks and syndiotactic blocks in the random-syndiotactic block polybutadiene prepared by this example is 70/30. The total content of the 1,2-butadiene structure in the polybutadiene is 63.0 wt %, wherein the content of the 1,2-butadiene structure in the random block is 52.4 wt %, and the content of the 1,2-butadiene structure in the syndiotactic block is 87.3 wt %. This polybutadiene has a number-average molecular weight of 11.1×10⁴, a molecular weight distribution index of 2.29, a glass-transition temperature of −39.4° C., and a melting point of 164.3° C.

### Example 2

Under nitrogen protection, 42 mL of hexane and 5 g of 1,3-butadiene were added to a 120 mL baked polymerization bottle, and then 0.54 mL of a hexane solution comprising 0.054 mmol ferric isooctanoate, 0.82 mL of a hexane solution comprising 0.164 mmol diethyl hydrogen phosphite and 0.28 mL of a hexane solution comprising 0.28 mmol triisobutyl aluminum were sequentially added. After shaken up, it was placed into a thermostatic water bath at 50° C. to carry out the first polymerization reaction. After polymerization for 4 h, 1.4 mL of a hexane solution comprising 1.4 mmol triisobutyl aluminum and 42 mL of a hexane solution comprising 5 g 1,3-butadiene were added to the polymerization bottle to carry out the second polymerization reaction. After polymerization for 2 h, 1 wt % 2,6-di-tert-butyl-p-cresol was added to the polymerization bottle to stop the reaction, obtaining a reaction product solution. The reaction product solution was subjected to ethanol for precipitation, and then dried to a constant weight in a vacuum oven at 40° C., obtaining a random-syndiotactic block polybutadiene with a yield of 85%.

The random-syndiotactic block polybutadiene prepared by this example was subjected to a structural and performance analysis, and results are as follows.

The random-syndiotactic block polybutadiene prepared by this example has a structure of formula (I), wherein m=1100, n=627, x=480, y=630, p=482, q=145. In the random-syndiotactic block polybutadiene prepared by this example, the mass ratio of the random block to the syndiotactic block is 50/50. The total content of the 1,2-butadiene structure in this polybutadiene is 65 wt %, wherein the content of the 1,2-butadiene structure in the random block is 43 wt %, and the content of the 1,2-butadiene structure in the syndiotactic block is 87 wt %. This polybutadiene has a number-average molecular weight of 12×10⁴, a molecular weight distribution index of 2.47, a glass-transition temperature of −39.8° C., and a melting point of 168.5° C.

### Example 3

Under nitrogen protection, 34 mL of raffinate oil and 4 g of 1,3-butadiene were added to a 120 mL baked polymerization bottle, and then 0.54 mL of a raffinate oil solution comprising 0.054 mmol ferric isooctanoate, 0.82 mL of a raffinate oil solution comprising 0.164 mmol diethyl hydrogen phosphite and 0.28 mL of a raffinate oil solution comprising 0.28 mmol triisobutyl aluminum were sequentially added. After shaken up, it was placed into a thermostatic water bath at 50° C. to carry out the first polymerization reaction. After polymerization for 4 h, 1.4 mL of a raffinate oil solution comprising 1.4 mmol triisobutyl aluminum and 51 mL of a raffinate oil solution comprising 6 g 1,3-butadiene were added to the polymerization bottle to carry out the second polymerization reaction. After polymerization for 2 h, an ethanol solution comprising 1 wt % 2,6-di-tert-butyl-p-cresol was added to the polymerization bottle to stop the reaction, obtaining a reaction product solution. The reaction product solution was subjected to ethanol for precipitation, and then dried to a constant weight in a vacuum oven at 40° C., obtaining a random-syndiotactic block polybutadiene with a yield of 87%.

The random-syndiotactic block polybutadiene prepared by this example was subjected to a structural and performance analysis, and results are as follows.

The random-syndiotactic block polybutadiene prepared by this example has a structure of formula (I), wherein m=900, n=760, x=420, y=480, p=600, q=160. In the random-syndiotactic block polybutadiene prepared by this example, the mass ratio of the random block to the syndiotactic block is 40/60. The total content of the 1,2-butadiene structure in this polybutadiene is 72 wt %, wherein the content of the 1,2-butadiene structure in the random block is 46.5 wt %, and the content of the 1,2-butadiene structure in the syndiotactic block is 89 wt %. This polybutadiene has a number-average molecular weight of 12.2×10⁴, a molecular weight distribution index of 2.68, a glass-transition temperature of −39.1° C., and a melting point of 168.8° C.

### Example 4

Under nitrogen protection, 25 mL of hexane and 3 g of 1,3-butadiene were added to a 120 mL baked polymerization bottle, and then 0.54 mL of a hexane solution comprising 0.054 mmol ferric isooctanoate, 0.82 mL of a hexane solution comprising 0.164 mmol diethyl hydrogen phosphite and 0.28 mL of a hexane solution comprising 0.28 mmol triisobutyl aluminum were sequentially added. After shaken up, it was placed into a thermostatic water bath at 50° C. to carry out the first polymerization reaction. After polymerization for 4 h, 1.4 mL of a hexane solution comprising 1.4 mmol triisobutyl aluminum and 59 mL of a hexane solution comprising 7 g 1,3-butadiene were added to the polymerization bottle to carry out the second polymerization reaction. After polymerization for 2 h, an ethanol solution comprising 1 wt % 2,6-di-tert-butyl-p-cresol was added to the polymerization bottle to stop the reaction, obtaining a reaction product solution. The reaction product solution was subjected to ethanol for precipitation, and then dried to a constant weight in a vacuum oven at 40° C., obtaining a random-syndiotactic block polybutadiene with a yield of 82%.

The random-syndiotactic block polybutadiene prepared by this example was subjected to a structural and performance analysis, and results are as follows.

The random-syndiotactic block polybutadiene prepared by this example has a structure of formula (I), wherein m=790, n=1010, x=350, y=440, p=840, q=170. In the random-syndiotactic block polybutadiene prepared by this Example, the mass ratio of the random block to the syndiotactic block is 30/70. The total content of the 1,2-butadiene structure in this polybutadiene is 77 wt %, wherein the content of the 1,2-butadiene structure in the random block is 44 wt %, and the content of the 1,2-butadiene structure in the syndiotactic block is 91 wt %. This polybutadiene has a number-average molecular weight of 14.3×10⁴, a molecular weight distribution index of 2.68, a glass-transition temperature of −39.6° C., and a melting point of 169.3° C.

### Example 5

Under nitrogen protection, 42 mL of hexane and 5 g of 1,3-butadiene were added to a 120 mL baked polymerization bottle, and then 0.18 mL of a hexane solution comprising 0.018 mmol ferric isooctanoate, 0.27 mL of a hexane solution comprising 0.054 mmol diethyl hydrogen phosphite and 0.14 mL of a hexane solution comprising 0.14 mmol triisobutyl aluminum were sequentially added. After shaken up, it was placed into a thermostaic water bath at 50° C. to carry out the first polymerization reaction. After polymerization for 4 h, 0.46 mL of a hexane solution comprising 0.46 mmol triisobutyl aluminum and 42 mL of a hexane solution comprising 5 g 1,3-butadiene were added to the polymerization bottle to carry out the second polymerization reaction. After polymerization for 2 h, an ethanol solution comprising 1 wt % 2,6-di-tert-butyl-p-cresol was added to the polymerization bottle to stop the reaction, obtaining a reaction product solution. The reaction product solution was subjected to ethanol for precipitation, and then dried to a constant weight in a vacuum oven at 40° C., obtaining a random-syndiotactic block polybutadiene with a yield of 85%.

The random-syndiotactic block polybutadiene prepared by this example was subjected to a structural and performance analysis, and results are as follows.

The random-syndiotactic block polybutadiene prepared by this example has a structure of formula (I), wherein m=2600, n=1390, x=1500, y=1100, p=1210, q=180. In the random-syndiotactic block polybutadiene prepared by this Example, the mass ratio of the random block to the syndiotactic block is 50/50. The total content of the 1,2-butadiene structure in this polybutadiene is 76 wt %, wherein the content of the 1,2-butadiene structure in the random block is 58 wt %, and the content of the 1,2-butadiene structure in the syndiotactic block is 93 wt %. This polybutadiene has a number-average molecular weight of 28×10⁴, a molecular weight distribution index of 2.56, a glass-transition temperature of −35.9° C., and a melting point of 168.3° C.

### Example 6

Under nitrogen protection, 42 mL of hexane and 5 g of 1,3-butadiene were added to a 120 mL baked polymerization bottle, and then 0.54 mL of a hexane solution comprising 0.054 mmol ferric isooctanoate, 0.82 mL of a hexane solution comprising 0.164 mmol diethyl hydrogen phosphite and 0.28 mL of a hexane solution comprising 0.28 mmol triethyl aluminum were sequentially added. After shaken up, it was placed into a thermostatic water bath at 50° C. to carry out the first polymerization reaction. After polymerization for 4 h, 1.4 mL of a hexane solution comprising 1.4 mmol triethyl aluminum and 42 mL of a hexane solution comprising 5 g 1,3-butadiene were added to the polymerization bottle to carry out the second polymerization reaction. After polymerization for 2 h, an ethanol solution comprising 1 wt % 2,6-di-tert-butyl-p-cresol was added to the polymerization bottle to stop the reaction, obtaining a reaction product solution. The reaction product solution was subjected to ethanol for precipitation, and then dried to a constant weight in a vacuum oven at 40° C., obtaining a random-syndiotactic block polybutadiene with a yield of 82%.

The random-syndiotactic block polybutadiene prepared by this example was subjected to a structural and performance analysis, and results are as follows.

The random-syndiotactic block polybutadiene prepared by this example has a structure of formula (I), wherein m=1400, n=800, x=800, y=600, p=600, q=200. In the random-syndiotactic block polybutadiene prepared by this example, the mass ratio of the random block to the syndiotactic block is 50/50. The total content of the 1,2-butadiene structure in this polybutadiene is 67 wt %, wherein the content of the 1,2-butadiene structure in the random block is 48 wt %, and the content of the 1,2-butadiene structure in syndiotactic block is 86 wt %. This polybutadiene has a number-average molecular weight of 15×10⁴, a molecular weight distribution index of 2.87, a glass-transition temperature of −35.7° C., and a melting point of 166.8° C.

### Example 7

Under nitrogen protection, 42 mL of hexane and 5 g of 1,3-butadiene were added to a 120 mL baked polymerization bottle, and then 0.54 mL of a hexane solution comprising 0.054 mmol ferric isooctanoate, 0.82 mL of a hexane solution comprising 0.164 mmol diethyl hydrogen phosphite and 0.28 mL of a hexane solution comprising 0.28 mmol diisobutylaluminum hydride were sequentially added. After shaken up, it was placed into a thermostatic water bath at 50° C. to carry out the first polymerization reaction. After polymerization for 4 h, 1.4 mL of a hexane solution comprising 1.4 mmol diisobutylaluminum hydride and 42 mL of a hexane solution comprising 5 g 1,3-butadiene were added to the polymerization bottle to carry out the second polymerization reaction. After polymerization for 2 h, an ethanol solution comprising 1 wt % 2,6-di-tert-butyl-p-cresol was added to the polymerization bottle to stop the reaction, obtaining a reaction product solution. The reaction product solution was subjected to ethanol for precipitation, and then dried to a constant weight in a vacuum oven at 40° C., obtaining a random-syndiotactic block polybutadiene with a yield of 68%.

The random-syndiotactic block polybutadiene prepared by this example was subjected to a structural and performance analysis, and results were as follows.

The random-syndiotactic block polybutadiene prepared by this example has a structure of formula (I), wherein m=920, n=545, x=400, y=520, p=375, q=170. In the random-syndiotactic block polybutadiene prepared by this example, the mass ratio of the random block to the syndiotactic block is 50/50. The total content of the 1,2-butadiene structure in this polybutadiene is 62 wt %, wherein the content of the 1,2-butadiene structure in the random block is 43 wt %, and the content of the 1,2-butadiene structure in the syndiotactic block is 81 wt %. This polybutadiene has a number-average molecular weight of 10×10⁴, a molecular weight distribution index of 3.10, a glass-transition temperature of −39.7° C., and a melting point of 162.6° C.

### Example 8

Under nitrogen protection, 42 mL of hexane and 5 g of 1,3-butadiene were added to a 120 mL baked polymerization bottle, and then 0.54 mL of a hexane solution comprising 0.054 mmol ferric isooctanoate, 0.27 mL of a hexane solution comprising 0.054 mmol dimethyl hydrogen phosphite and 0.28 mL of a hexane solution comprising 0.28 mmol triisobutyl aluminum were sequentially added. After shaken up, it was placed into a thermostatic water bath at 50° C. to carry out the first polymerization reaction. After polymerization for 4 h, 1.4 mL of a hexane solution comprising 1.4 mmol triisobutyl aluminum and 42 mL of a hexane solution comprising 5 g 1,3-butadiene were added to the polymerization bottle to carry out the second polymerization reaction. After polymerization for 2 h, an ethanol solution comprising 1 wt % 2,6-di-tert-butyl-p-cresol was added to the polymerization bottle to stop the reaction, obtaining a reaction product solution. The reaction product solution was subjected to ethanol for precipitation, and then dried to a constant weight in a vacuum oven at 40° C., obtaining a random-syndiotactic block polybutadiene with a yield of 78%.

The random-syndiotactic block polybutadiene prepared by this example was subjected to a structural and performance analysis, and results are as follows.

The random-syndiotactic block polybutadiene prepared by this example has a structure of formula (I), wherein m=1480, n=860, x=770, y=710, p=620, q=240. In the random-syndiotactic block polybutadiene prepared by this Example, the mass ratio of the random block to the syndiotactic block is 50/50. The total content of the 1,2-butadiene structure in this polybutadiene is 68 wt %, wherein the content of the 1,2-butadiene structure in the random block is 52 wt %, and the content of the 1,2-butadiene structure in the syndiotactic block is 84 wt %. This polybutadiene has a number-average molecular weight of 16×10⁴, a molecular weight distribution index of 2.38, a glass-transition temperature of −37.4° C., and a melting point of 167.9° C.

### Example 9

Under nitrogen protection, 42 mL of hexane and 5 g of 1,3-butadiene were added to a 120 mL baked polymerization bottle, and then 0.54 mL of a hexane solution comprising 0.054 mmol ferric isooctanoate, 0.54 mL of a hexane solution comprising 0.108 mmol n-butyl hydrogen phosphite and 0.28 mL of a hexane solution comprising 0.28 mmol triisobutyl aluminum were sequentially added. After shaken up, it was placed in a thermostatic water bath at 50° C. to carry out the first polymerization reaction. After polymerization for 4 h, 1.4 mL of a hexane solution comprising 1.4 mmol triisobutyl aluminum and 42 mL of a hexane solution comprising 5 g 1,3-butadiene were added to the polymerization bottle to carry out the second polymerization reaction. After polymerization for 2 h, an ethanol solution comprising 1 wt % 2,6-di-tert-butyl-p-cresol was added to the polymerization bottle to stop the reaction, obtaining a reaction product solution. The reaction product solution was subjected to ethanol precipitation, and then dried to a constant weight in a vacuum oven at 40° C., obtaining a random-syndiotactic block polybutadiene with a yield of 72%.

The random-syndiotactic block polybutadiene prepared by this example was subjected to a structural and performance analysis, and results are as follows.

The random-syndiotactic block polybutadiene prepared by this example has a structure of formula (I), wherein m=1200, n=650, x=580, y=620, p=550, q=100. In the random-syndiotactic block polybutadiene prepared by this Example, the mass ratio of the random block to the syndiotactic block is 50/50. The total content of the 1,2-butadiene structure in this polybutadiene is 70 wt %, wherein the content of the 1,2-butadiene structure in the random block is 49 wt %, and the content of the 1,2-butadiene structure in the syndiotactic block is 91 wt %. This polybutadiene has a number-average molecular weight of 13×10⁴, a molecular weight distribution index of 2.87, a glass-transition temperature of −38.0° C., and a melting point of 171.9° C.

### Example 10

Under nitrogen protection, 42 mL of hexane and 5 g of 1,3-butadiene were added to a 120 mL baked polymerization bottle, and then 0.54 mL of a hexane solution comprising 0.054 mmol ferric isooctanoate, 0.82 mL of a hexane solution comprising 0.164 mmol diphenyl hydrogen phosphite and 0.28 mL of a hexane solution comprising 0.28 mmol triisobutyl aluminum were sequentially added. After shaken up, it was placed into a thermostatic water bath at 50° C. to carry out the first polymerization reaction. After polymerization for 4 h, 1.4 mL of a hexane solution comprising 1.4 mmol triisobutyl aluminum and 42 mL of a hexane solution comprising 5 g 1,3-butadiene were added to the polymerization bottle to carry out the second polymerization reaction. After polymerization for 2 h, an ethanol solution comprising 1 wt % 2,6-di-tert-butyl-p-cresol was added to the polymerization bottle to stop the reaction, obtaining a reaction product solution. The reaction product solution was subjected to ethanol for precipitation, and then dried to a constant weight in a vacuum oven at 40° C., obtaining a random-syndiotactic block polybutadiene with a yield of 68%.

The random-syndiotactic block polybutadiene prepared by this example was subjected to a structural and performance analysis, and results are as follows.

The random-syndiotactic block polybutadiene prepared by this example has a structure of formula (I), wherein m=1950, n=1035, x=970, y=980, p=915, q=120. In the random-syndiotactic block polybutadiene prepared by this Example, the mass ratio of the random block to the syndiotactic block is 50/50. The total content of the 1,2-butadiene structure in this polybutadiene is 72 wt %, wherein the content of the 1,2-butadiene structure in the random block is 50 wt %, and the content of the 1,2-butadiene structure in the syndiotactic block is 94 wt %. This polybutadiene has a number-average molecular weight of 21×10⁴, a molecular weight distribution index of 2.56, a glass-transition temperature of −37.9° C., and a melting point of 178.9° C.

### Example 11

Under nitrogen protection, 42 mL of hexane and 5 g of 1,3-butadiene were added to a 120 mL baked polymerization bottle, and then 0.54 mL of a hexane solution comprising 0.054 mmol ferrous isooctanoate, 0.82 mL of a hexane solution comprising 0.164 mmol diethyl hydrogen phosphite and 0.28 mL of a hexane solution comprising 0.28 mmol triisobutyl aluminum were sequentially added. After shaken up, it was placed into a thermostatic water bath at 50° C. to carry out the first polymerization reaction. After polymerization for 4 h, 1.4 mL of a hexane solution comprising 1.4 mmol triisobutyl aluminum and 42 mL of a hexane solution comprising 5 g 1,3-butadiene were added to the polymerization bottle to carry out the second polymerization reaction. After polymerization for 2 h, an ethanol solution comprising 1 wt % 2,6-di-tert-butyl-p-cresol was added to the polymerization bottle to stop the reaction, obtaining a reaction product solution. The reaction product solution was subjected to ethanol for precipitation, and then dried to a constant weight in a vacuum oven at 40° C., obtaining a random-syndiotactic block polybutadiene with a yield of 69%.

The random-syndiotactic block polybutadiene prepared by this example was subjected to a structural and performance analysis, and results are as follows.

The random-syndiotactic block polybutadiene prepared by this example has a structure of formula (I), wherein m=1300, n=770, x=570, y=730, p=530, q=240. In the random-syndiotactic block polybutadiene prepared by this example, the mass ratio of the random block to the syndiotactic block is 50/50. The total content of the 1,2-butadiene structure in this polybutadiene is 63 wt %, wherein the content of the 1,2-butadiene structure in the random block is 44 wt %, and the content of the 1,2-butadiene structure in the syndiotactic block is 82 wt %. This polybutadiene has a number-average molecular weight of 14×10⁴, a molecular weight distribution index of 2.83, a glass-transition temperature of −40.0° C., and a melting point of 167.8° C.

### Example 12

Under nitrogen protection, 42 mL of hexane and 5 g of 1,3-butadiene were added to a 120 mL baked polymerization bottle, and then 0.54 mL of a hexane solution comprising 0.054 mmol ferric naphthenate, 0.82 mL of a hexane solution comprising 0.164 mmol diethyl hydrogen phosphite and 0.28 mL of a hexane solution comprising 0.28 mmol triisobutyl aluminum were added sequentially. After shaken up, it was placed into a thermostatic water bath at 50° C. to carry out the first polymerization reaction. After polymerization for 4 h, 1.4 mL of a hexane solution comprising 1.4 mmol triisobutyl aluminum and 42 mL of a hexane solution comprising 5 g 1,3-butadiene were added to the polymerization bottle to carry out the second polymerization reaction. After polymerization for 2 h, an ethanol solution comprising 1 wt % 2,6-di-tert-butyl-p-cresol was added to the polymerization bottle to stop the reaction, obtaining a reaction product solution. The reaction product solution was subjected to ethanol for precipitation, and then dried to a constant weight in a vacuum oven at 40° C., obtaining a random-syndiotactic block polybutadiene with a yield of 73%.

The random-syndiotactic block polybutadiene prepared by this example was subjected to a structural and performance analysis, and results are as follows.

The random-syndiotactic block polybutadiene prepared by this example has a structure of formula (I), wherein m=1600, n=950, x=700, y=900, p=650, q=300. In the random-syndiotactic block polybutadiene prepared by this example, the mass ratio of the random block to the syndiotactic block is 50/50. The total content of the 1,2-butadiene structure in this polybutadiene is 63 wt %, wherein the content of the 1,2-butadiene structure in the random block is 44 wt %, and the content of the 1,2-butadiene structure in the syndiotactic block is 82 wt %. This polybutadiene has a number-average molecular weight of 17×10⁴, a molecular weight distribution index of 2.98, a glass-transition temperature of −39.9° C., and a melting point of 168.0° C.

### Example 13

Under nitrogen protection, 42 mL of hexane and 5 g of 1,3-butadiene were added to a 120 mL baked polymerization bottle, and then 0.54 mL of a hexane solution comprising 0.054 mmol ferrous naphthenate, 0.82 mL of a hexane solution comprising 0.164 mmol diethyl hydrogen phosphite and 0.28 mL of a hexane solution comprising 0.28 mmol triisobutyl aluminum were added sequentially. After shaken up, it was placed into a thermostatic water bath at 50° C. to carry out the first polymerization reaction. After polymerization for 4 h, 1.4 mL of a hexane solution comprising 1.4 mmol triisobutyl aluminum and 42 mL of a hexane solution comprising 5 g 1,3-butadiene were added to the polymerization bottle to carry out the second polymerization reaction. After polymerization for 2 h, an ethanol solution comprising 1 wt % 2,6-di-tert-butyl-p-cresol was added to the polymerization bottle to stop the reaction, obtaining a reaction product solution. The reaction product solution was subjected to ethanol for precipitation, and then dried to a constant weight in a vacuum oven at 40° C., obtaining a random-syndiotactic block polybutadiene with a yield of 68%.

The random-syndiotactic block polybutadiene prepared by this example was subjected to a structural and performance analysis, and results are as follows.

The random-syndiotactic block polybutadiene prepared by this example has a structure of formula (I), wherein m=1760, n=1010, x=810, y=950, p=750, q=260. In the random-syndiotactic block polybutadiene prepared by this Example, the mass ratio of the random block to the syndiotactic block is 50/50. The total content of the 1,2-butadiene structure in this polybutadiene is 65 wt %, wherein the content of the 1,2-butadiene structure in the random block is 46 wt %, and the content of the 1,2-butadiene structure in the syndiotactic block is 84 wt %. This polybutadiene has a number-average molecular weight of 19×10⁴, a molecular weight distribution index of 2.28, a glass-transition temperature of −38.9° C., and a melting point of 168.4° C.

### Example 14

Under nitrogen protection, 42 mL of hexane and 5 g of 1,3-butadiene were added to a 120 mL baked polymerization bottle, and then 0.54 mL of a hexane solution comprising 0.054 mmol ferric neodecanoate, 0.82 mL of a hexane solution comprising 0.164 mmol diethyl hydrogen phosphite and 0.28 mL of a hexane solution comprising 0.28 mmol triisobutyl aluminum were added sequentially. After shaken up, it was placed into a thermostatic water bath at 50° C. to carry out the first polymerization reaction. After polymerization for 4 h, 1.4 mL of a hexane solution comprising 1.4 mmol triisobutyl aluminum and 42 mL of a hexane solution comprising 5 g 1,3-butadiene were added to the polymerization bottle to carry out the second polymerization reaction. After polymerization for 2 h, an ethanol solution comprising 1 wt % 2,6-di-tert-butyl-p-cresol was added to the polymerization bottle to stop the reaction, obtaining a reaction product solution. The reaction product solution is subjected to ethanol for precipitation, and then dried to a constant weight in a vacuum oven at 40° C., obtaining a random-syndiotactic block polybutadiene with a yield of 70%.

The random-syndiotactic block polybutadiene prepared by this example was subjected to a structural and performance analysis, and results are as follows.

The random-syndiotactic block polybutadiene prepared by this example has a structure of formula (I), wherein m=2000, n=1150, x=930, y=1070, p=850, q=300. In the random-syndiotactic block polybutadiene prepared by this Example, the mass ratio of the random block to the syndiotactic block is 50/50. The total content of the 1,2-butadiene structure in this polybutadiene is 65 wt %, wherein the content of the 1,2-butadiene structure in the random block is 46 wt %, and the content of the 1,2-butadiene structure in the syndiotactic block is 84 wt %. This polybutadiene has a number-average molecular weight of 22×10⁴, a molecular weight distribution index of 2.66, a glass-transition temperature of −39.0° C., and a melting point of 168.4° C.

### Example 15

Under nitrogen protection, 42 mL of hexane and 5 g of 1,3-butadiene were added to 120 mL baked polymerization bottle, and then 0.54 mL of a hexane solution comprising 0.054 mmol ferric acetylacetonate, 0.82 mL of a hexane solution comprising 0.164 mmol diethyl hydrogen phosphite and 0.28 mL of a hexane solution comprising 0.28 mmol triisobutyl aluminum were sequentially added. After shaken up, it was placed into a thermostatic water bath at 50° C. to carry out the first polymerization reaction. After polymerization for 4 h, 1.4 mL of a hexane solution comprising 1.4 mmol triisobutyl aluminum and 42 mL of a hexane solution comprising 5 g 1,3-butadiene were added to the polymerization bottle to carry out the second polymerization reaction. After polymerization for 2 h, an ethanol solution comprising 1 wt % 2,6-di-tert-butyl-p-cresol was added to the polymerization bottle to stop the reaction, obtaining a reaction product solution. The reaction product solution is subjected to ethanol for precipitation, and then dried to a constant weight in a vacuum oven at 40° C., obtaining a random-syndiotactic block polybutadiene with a yield of 86%.

The random-syndiotactic block polybutadiene prepared by this example was subjected to a structural and performance analysis, and results are as follows.

The random-syndiotactic block polybutadiene prepared by this example has a structure of formula (I), wherein m=2050, n=1125, x=860, y=1190, p=925, q=200. In the random-syndiotactic block polybutadiene prepared by this Example, the mass ratio of the random block to the syndiotactic block is 50/50. The total content of the 1,2-butadiene structure in this polybutadiene is 65 wt %, wherein the content of the 1,2-butadiene structure in the random block is 42 wt %, and the content of the 1,2-butadiene structure in the syndiotactic block is 90 wt %. This polybutadiene has a number-average molecular weight of 22×10⁴, a molecular weight distribution index of 2.66, a glass-transition temperature of −26.1° C., and a melting point of 168.4° C.

### Example 16

Under nitrogen protection, 42 mL of hexane and 5 g of 1,3-butadiene were added to a 120 mL baked polymerization bottle, and then 0.54 mL of a hexane solution comprising 0.054 mmol ferrous acetylacetonate, 0.82 mL of a hexane solution comprising 0.164 mmol diethyl hydrogen phosphite and 0.28 mL of a hexane solution comprising 0.28 mmol triisobutyl aluminum were sequentially added. After shaken up, it was placed into a thermostatic water bath at 50° C. to carry out the first polymerization reaction. After polymerization for 4 h, 1.4 mL of a hexane solution comprising 1.4 mmol triisobutyl aluminum and 42 mL of a hexane solution comprising 5 g 1,3-butadiene were added to the polymerization bottle to carry out the second polymerization reaction. After polymerization for 2 h, an ethanol solution comprising 1 wt % 2,6-di-tert-butyl-p-cresol was added to the polymerization bottle to stop the reaction, obtaining a reaction product solution. The reaction product solution was subjected to ethanol for precipitation, and then dried to a constant weight in a vacuum oven at 40° C., obtaining a random-syndiotactic block polybutadiene with a yield of 86%.

The random-syndiotactic block polybutadiene prepared by this example was subjected to a structural and performance analysis, and results are as follows.

The random-syndiotactic block polybutadiene prepared by this example has a structure of formula (I), wherein m=2050, n=1120, x=940, y=1110, p=930, q=190. In the random-syndiotactic block polybutadiene prepared by this example, the mass ratio of the random block to the syndiotactic block is 50/50. The total content of the 1,2-butadiene structure in this polybutadiene is 68 wt %, wherein the content of the 1,2-butadiene structure in the random block is 46 wt %, and the content of the 1,2-butadiene structure in the syndiotactic block is 91 wt %. This polybutadiene has a number-average molecular weight of 22×10⁴, a molecular weight distribution index of 2.66, a glass-transition temperature of −25.8° C., and a melting point of 169.4° C.

### Comparative Example 1

Under nitrogen protection, 42 mL of hexane and 5 g of 1,3-butadiene were added to a 120 mL baked polymerization bottle, and then 0.54 mL of a hexane solution comprising 0.054 mmol ferric isooctanoate, 0.82 mL of a hexane solution comprising 0.164 mmol diethyl hydrogen phosphite and 0.28 mL of a hexane solution comprising 0.28 mmol triisobutyl aluminum were added sequentially. After shaken up, it was placed into a thermostatic water bath at 50° C. to perform polymerization reaction. After polymerization for 4 h, an ethanol solution comprising 1 wt % 2,6-di-tert-butyl-p-cresol was added to the polymerization bottle to stop the reaction, obtaining a reaction product solution. The reaction product solution was subjected to ethanol for precipitation, and then dried to a constant weight in a vacuum oven at 40° C., obtaining a random binary cis-1,4/1,2-polybutadiene rubber with a yield of 95%.

The polybutadiene rubber prepared by this comparative example was subjected to a structural and performance analysis, and results are as follows.

The polybutadiene rubber prepared by this comparative example has a structure of formula (II), wherein m=1100, x=550, y=550. The content of the 1,2-butadiene structure in the random polybutadiene prepared by this comparative example is 50 wt %. This polybutadiene has a number-average molecular weight of 6×10⁴, a molecular weight distribution index of 2.13, and a glass-transition temperature of −38.0° C.

It can be seen that, a polymer comprising a random cis-1,4/1,2-polybutadiene structure has a glass-transition temperature of about −38.0° C.

### Comparative Example 2

Under nitrogen protection, 42 mL of hexane and 5 g of 1,3-butadiene were added to a 120 mL baked polymerization bottle, and then 0.54 mL of a hexane solution comprising 0.054 mmol ferric isooctanoate, 0.82 mL of a hexane solution comprising 0.164 mmol diethyl hydrogen phosphite and 1.62 mL of a hexane solution comprising 1.62 mmol triisobutyl aluminum were added sequentially. After shaken up, it was placed into a thermostatic water bath at 50° C. to carry out the polymerization reaction. After polymerization for 4 h, an ethanol solution comprising 1 wt % 2,6-di-tert-butyl-p-cresol was added to the polymerization bottle to stop the reaction, obtaining a reaction product solution. The reaction product solution was subjected to ethanol for precipitation, and then dried to a constant weight in a vacuum oven at 40° C., obtaining a syndiotactic 1,2-polybutadiene with a yield of 98%.

The syndiotactic 1,2-polybutadiene prepared by this comparative example was subjected to a structural and performance analysis, and results are as follows.

The syndiotactic 1,2-polybutadiene prepared by this comparative example has a structure of the following formula:

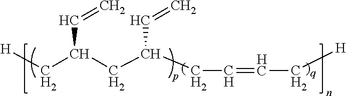

wherein n=825, p=675, q=150.

The content of the 1,2-butadiene structure in the syndiotactic 1,2-polybutadiene prepared by this comparative example is 91.7 wt %. This polybutadiene has a number-average molecular weight of 8×10⁴, a molecular weight distribution index of 2.16, and a melting point of 169° C.

It can be seen that, a polymer comprising a syndiotactic 1,2-polybutadiene segment has a melting point of about 169° C.

### Example 17

### Compatibility Experiment

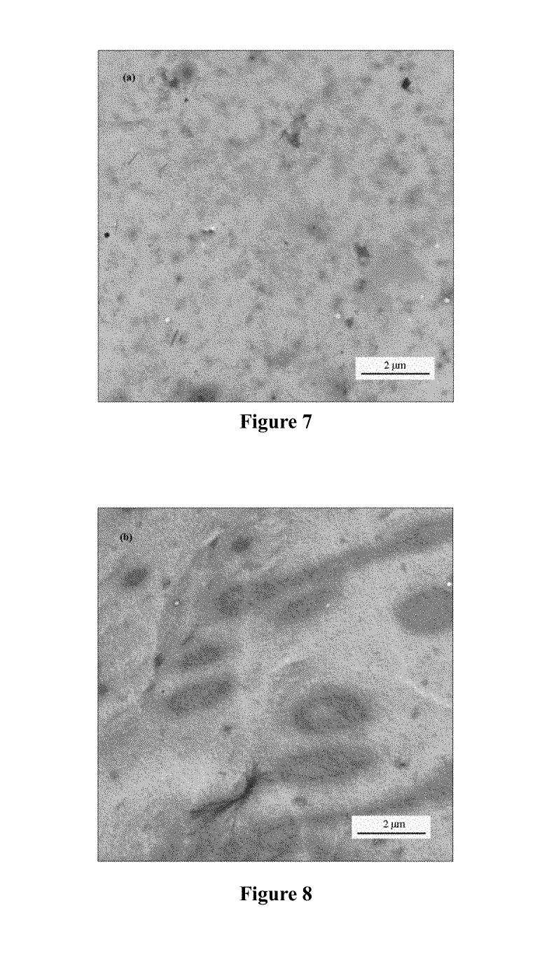

The random-syndiotactic block polybutadiene prepared by Example 1 was observed by a transmission electron microscope (TEM), and results are shown in FIG. 7. FIG. 7 is a TEM image of the random-syndiotactic block polybutadiene prepared in Example 1 of the present invention. As can be seen from FIG. 7, the random-syndiotactic block polybutadiene provided in Example 1 exhibits a very homogeneous micro phase separation.

The random binary cis-1,4/1,2-polybutadiene rubber prepared in Comparative example 1 and the syndiotactic 1,2-polybutadiene prepared in Comparative example 2 were mixed in a mass ratio of 1:1, and the mixture obtained by mixing was observed by a transmission electron microscope (TEM), with results shown in FIG. 8. FIG. 8 is a TEM image of a mixture of the polymers prepared in Comparative example 1 and Comparative example 2 of the present invention. As can be seen from FIG. 7, this mixture exhibits an irregular macro phase separation, which illustrates that the compatibility of the random binary cis-1,4/1,2-polybutadiene rubber and the syndiotactic 1,2-polybutadiene is poor.

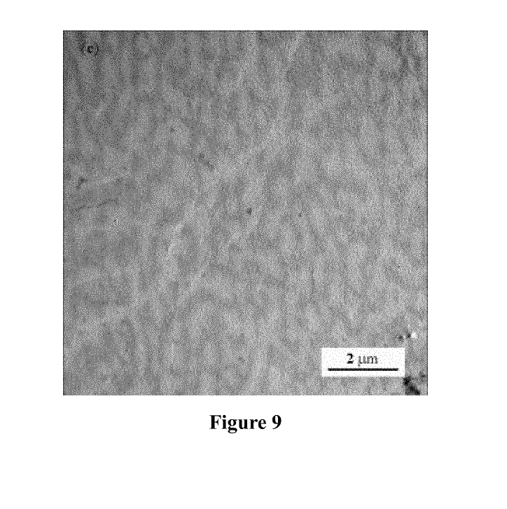

The random binary cis-1,4/1,2-polybutadiene rubber prepared in Comparative example 1, the syndiotactic 1,2-polybutadiene prepared in Comparative example 2 and the random-syndiotactic block polybutadiene prepared in an example were mixed in a mass ratio of 5.5:5.5:2.3, and the mixture obtained by mixing was observed by a transmission electron microscope (TEM), with results shown in FIG. 9. FIG. 9 is a TEM image of a mixture of the polymers prepared in Example 1, Comparative example 1 and Comparative example 2 of the present invention. As can be seen from FIG. 9, the apparent homogeneity of the mixture is good, which illustrates that the addition of a random-syndiotactic block polybutadiene can significantly increase the compatibility of the syndiotactic 1,2-polybutadiene/polybutadiene rubber blend.

The foregoing descriptions are merely preferred embodiments of the present invention, and it is to be noted, for those skilled in the art, several improvements and modifications may be made without departing from the principle of the present invention, which are deemed to be within the protection scope of the present invention.

1. A random-syndiotactic block polybutadiene having a structure of formula (I): 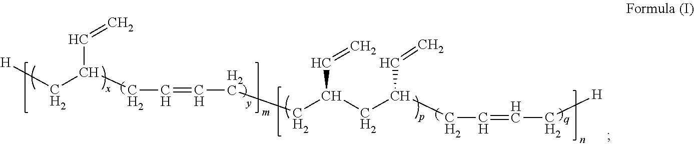
wherein 250≦m≦5000; 100≦n≦3000; 100≦x≦3000, 150≦y≦2000, x+y=m; 70≦p≦2500, 30≦q≦500, p+q=n.

2. The polybutadiene of claim 1, characterized in that 500≦m≦2500; 300≦n≦1500; 200≦x≦1500, 300≦y≦1000; 150≦p≦1250, 50≦q≦250.

3. A method for preparing a random-syndiotactic block polybutadiene, comprising the steps of:
a) mixing 1,3-butadiene, a catalyst and a solvent to carry out a reaction, obtaining a prepolymer;
b) mixing the prepolymer, 1,3-butadiene, an organic-aluminum compound and a solvent to carry out a reaction, obtaining a random-syndiotactic block polybutadiene having a structure of formula (I); 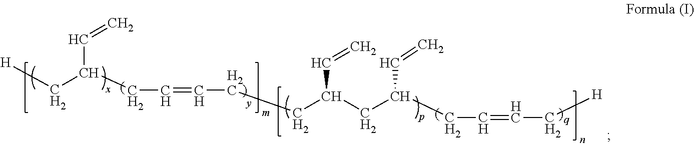
wherein 250≦m≦5000; 100≦n≦3000; 100≦x≦3000, 150≦y≦2000, x+y=m; 70≦p≦2500, 30≦q≦500, p+q=n.

4. The method of claim 3, characterized in that in step a), a ratio of the 1,3-butadiene to the catalyst is 1˜10 (g):0.01˜10 (mmol).

5. The method of claim 3, characterized in that in step a), a duration of the reaction is 1˜6 h; and a temperature of the reaction is 30˜80° C.

6. The method of claim 3, characterized in that in step b), the organic-aluminum compound is one or more of triethyl aluminum, triisobutyl aluminum and diisobutylaluminum hydride.

7. The method of claim 3, characterized in that in step b), a ratio of the 1,3-butadiene to the organic-aluminum compound is 7˜3 (g):0.1˜5 (mmol).

8. The method of claim 3, characterized in that in step b), a duration of the reaction is 1˜4 h; and the temperature of the reaction is 30˜80° C.

9. The method of claim 3, characterized in that a mass ratio of the 1,3-butadiene in step a) to the 1,3-butadiene in step b) is 3˜7:7˜3.

10. The method of claim 3, characterized in that the catalyst is an organic-ferric compound, an organic-aluminum compound and a dialkyl hydrogen phosphite compound.
